(19) United States
(12) Patent Application Publication
(10) Pub. No.: US 2026/0361801 A1
(43) Pub. Date: Nov. 12, 2026

(54) DYNAMIC, TOKEN-BASED CONTENT DELIVERY SYSTEM

(71) Applicant: Capital One Services, LLC, McLean, VA (US)

(72) Inventors: Bryan TAMAYO, Allen, TX (US); Erik SALES, Van Alstyne, TX (US)

(21) Appl. No.: 19/203,398

(22) Filed: May 9, 2025

(51) Int. Cl. H04L 67/60; H04L 9/40; H04L 67/306

(52) U.S. Cl. CPC H04L 67/60; H04L 63/083; H04L 67/306

(57) ABSTRACT

In some implementations, a system may receive, from a client device, a request for display content, wherein the client device is associated with a client profile. The system may obtain a set of content assets responsive to the request. The system may obtain decision information defining one or more conditions for selecting a content asset from the set of content assets, where the decision information is associated with the client profile and includes one or more display parameters for selecting a content asset. The system may select a content asset from the set of content assets based on the decision information. The system may generate a content element associated with the selected content asset, wherein the content element includes a token associated with one or more conditions for providing the content asset to a device. The system may provide the content element to the client device.

### BACKGROUND

A user interface (UI) allows users to interact with electronic devices. A web browser may provide a UI that presents web pages that include content. A user may navigate to a web page by entering a web address into an address bar of the web browser and/or by clicking a link displayed via another web page. Additionally, an application on a smartphone, laptop, tablet, or other device may provide a UI that presents content. Navigation to a web page or to an application-based UI may consume resources of a user device on which the web browser or application is installed, may consume resources of a web server or content server that serves the web page and/or content to the user device, and may consume network resources used for communications between the user device and the web server.

### SUMMARY

In some implementations, a system for dynamic content delivery includes one or more memories; and one or more processors, communicatively coupled to the one or more memories, configured to: receive, from a client device, a request for display content, wherein the client device is associated with a client profile; obtain a set of content assets responsive to the request; obtain decision information defining one or more conditions for selecting a content asset from a set of content assets, wherein the decision information is associated with the client profile and includes one or more display parameters for selecting a content asset from the set of content assets; select a content asset from the set of content assets based on the decision information; generate a content element associated with the selected content asset, wherein the content element includes a token associated with one or more conditions for providing the content asset to a device; and provide the content element to the client device.

In some implementations, a method for dynamic content delivery includes receiving, from a client device, a request for display content, wherein the client device is associated with a client profile; obtaining, by a system, a set of content assets responsive to the request; obtaining, by the system, decision information defining one or more conditions for selecting a content asset from a set of content assets, wherein the decision information is associated with the client profile and includes one or more display parameters for selecting a content asset from the set of content assets; selecting, by the system, a content asset from the set of content assets based on the decision information; generating, by the system, a content element associated with the selected content asset, wherein the content element includes a token associated with one or more conditions for providing the content asset to a device; and providing, by the system, the content element to the client device.

In some implementations, a non-transitory computer-readable medium storing a set of instructions includes one or more instructions that, when executed by one or more processors of a system, cause the system to: receive, from a client device, a request for display content, wherein the client device is associated with a client profile; obtain a set of content assets responsive to the request; obtain decision information defining one or more conditions for selecting a content asset from a set of content assets, wherein the decision information is associated with the client profile and includes one or more display parameters for selecting a content asset from the set of content assets; select a content asset from the set of content assets based on the decision information; generate a content element associated with the selected content asset, wherein the content element includes a token associated with one or more conditions for providing the content asset to a device; and provide the content element to the client device.

### BRIEF DESCRIPTION OF THE DRAWINGS

FIG. 1 is a diagram of an example associated with dynamic, token-based content delivery system, in accordance with some embodiments of the present disclosure.

FIGS. 2A-2B are diagrams of an example environment associated with dynamic, token-based content delivery, in accordance with some embodiments of the present disclosure.

FIG. 3 is a diagram of an example of training and using a machine learning model in connection with dynamic, token-based content delivery, in accordance with some embodiments of the present disclosure.

FIG. 4 is a diagram of an example environment in which systems and/or methods described herein may be implemented, in accordance with some embodiments of the present disclosure.

FIG. 5 is a diagram of example components of a device associated with a dynamic, token-based content delivery system, in accordance with some embodiments of the present disclosure.

FIG. 6 is a flowchart of an example process associated with a dynamic, token-based content delivery system, in accordance with some embodiments of the present disclosure.

### DETAILED DESCRIPTION

The following detailed description of example implementations refers to the accompanying drawings. The same reference numbers in different drawings may identify the same or similar elements.

A web page or an application may provide an interface for accessing information and/or services via the Internet. The web page or application may incorporate content that is to be displayed in a user interface (UI), such as a web browser or in an application interface (e.g., a mobile application interface). In some examples, the web page or application may include embedded code that may be utilized by a web browser or the application to request content (e.g., images, videos, text, and/or interactive elements, among other examples) or other resources from a web server that hosts the content or other resources. In this way, a web browser or application accessing a web page that includes the embedded code may request and receive the content associated with the embedded code. For example, a user may utilize a web browser to access a web page, and the web browser may receive an image file (e.g., from a server hosting the image) and display the image, associated with the image file, to the user via the web browser.

However, a hosting entity (e.g., an entity that hosts the content on a server or an entity that provides access to content hosted on a server, among other examples) may be unable to selectively authorize access to and/or delivery of content associated with the hosting entity. For example, a client of the hosting entity may be able to include the hosting entity's content on the client's platform (e.g., a web page, an application, or the like) by including embedded code on the platform in order to requests the content. In other words, one or more clients may have unrestricted access to request the hosting entity's content for inclusion on the clients'platforms. As a result, the hosting entity may be unable to monitor usage of the content on the clients'platforms. Furthermore, the hosting entity may be unable to selectively restrict or revoke access to the content among different clients, and/or the hosting entity may be unable to dynamically update or adapt the content that is utilized by the client.

Additionally, in circumstances in which one or more clients have unrestricted access to request the hosting entity's content for inclusion on the clients'platforms, the clients may utilize content that is unsuitable for a specific platform (e.g., utilizing content formatted for a desktop browser in a mobile application) or the clients may utilize content that is irrelevant or outdated. Accordingly, when users of a web page or application are provided with irrelevant and/or undesired content, the users may cease to actively engage with a web page or application and/or may leave the web page or application. For example, a web page may fail to retain user attention and/or to drive conversions due to factors such as static, generic, and/or out-of-date content and call-to-action (CTA) elements and/or a lack of personalized content or recommendations tailored to user interest, intent, and preferences, among other examples.

Some implementations described herein enable dynamically delivering content in a UI (e.g., a web browser or an application, among other examples) by using a token-based content element. For example, where a client (e.g., via an client device) obtains a content element (e.g., an embeddable code) associated with a content asset (e.g., an image or video asset) from an entity, the client may utilize the content element to enable a web browser to request the content asset, via the content element. Furthermore, where the content element is associated with a token, the system may monitor usage of the content element in order to restrict access to the content asset and/or to update or adapt the content asset. For example, the system may cease delivering content assets to a web page (e.g., a web page that includes a content element for requesting the content assets) based on the client, associated with the web page, losing authorization for the content assets. Similarly, for example, the system may refrain from delivering a content asset to a web page based on the content asset being unsuitable for the web page (e.g., where the content asset is formatted for a mobile application, and the content asset is unsuitable for a desktop browser). Instead, the system may deliver an updated or adapted content asset that is suitable for the platform (e.g., the web page) or format.

As a result, a system may monitor and restrict access to and delivery of content assets. In this way, computing resources and/or network resources may be conserved by reducing delivery of content assets to unauthorized platforms (e.g., web pages, applications, or the like) and/or by avoiding delivery of out-of-date content assets or content that is unsuitable for a platform (e.g., content assets that are not formatted or sized for a web-based platform). For example, delivering content that is unsuitable for a platform (e.g., a desktop-based browser versus a mobile application) or that is unauthorized for use on a web page associated with a specific client, may cause higher processor and memory usage on backend servers that host, provide, and deliver content to unauthorized platforms (e.g., associated with an unauthorized client). Similarly, for example, delivery of outdated or irrelevant content (e.g., irrelevant to a specific web page, platform, and/or context) may result in unnecessary processor and memory usage on backend servers that host, provide, and deliver content to a platform (e.g., a web page, mobile application, or the like) associated with a client. Additionally, it is infeasible to monitor usage across individual web pages or platforms in a situation where a content asset may be accessible without restriction. In contrast, by utilizing a dynamic, token-based content delivery system, backend servers may provide and deliver content only to authorized platforms (e.g., associated with authorized client) and may provide and deliver content that is up-to-date.

Furthermore, by adapting and updating content assets associated with a content element (e.g., a content element embedded on a web page in order to request content assets for the web page), the system may conserve resources that may otherwise be consumed where a user leaves the web page, is unable to efficiently navigate the webpage, or becomes inactive on the webpage. Additionally, by adapting and updating the content assets based on user behavior, user interaction history, user profiles, or the like, some implementations described herein may increase conversion rates or interactions, improve user experience, and avoid wasting resources that may have been consumed by the user navigating and interacting with the web page without completing a conversion action and/or without completing the task that the user intended to perform. Similarly, computing resources and/or network resources may be conserved by reducing an amount of navigation performed by a user. For example, inefficient user navigation across pages on a web page, or resulting from a user being present with irrelevant or out-of-date content assets, may cause higher processor and memory usage on backend servers as requests for the content assets are processed.

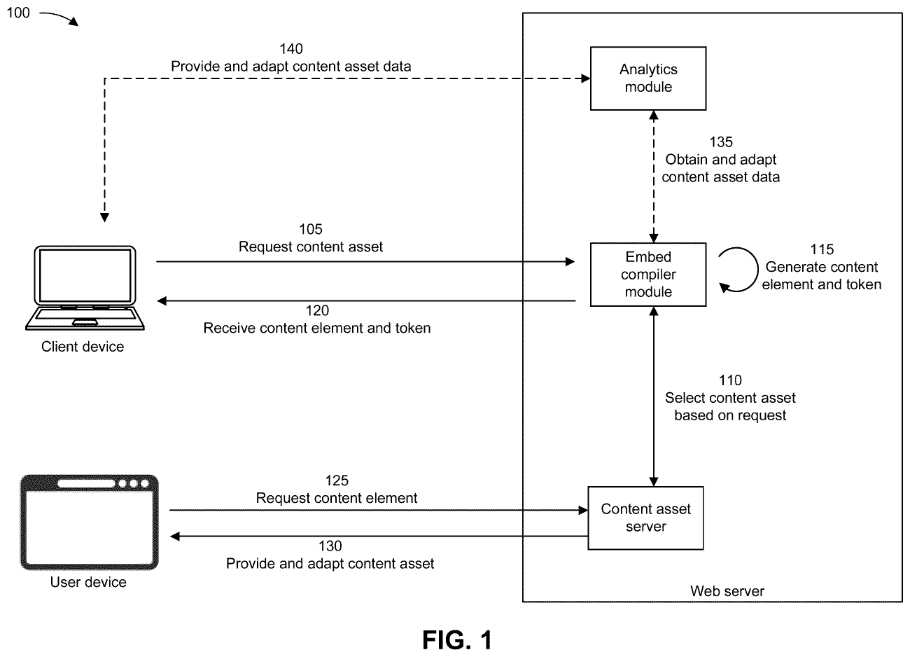

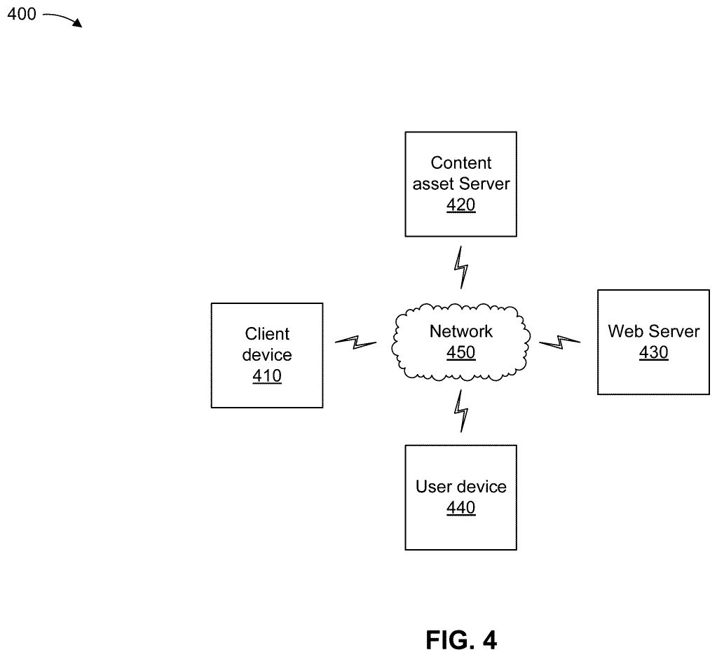

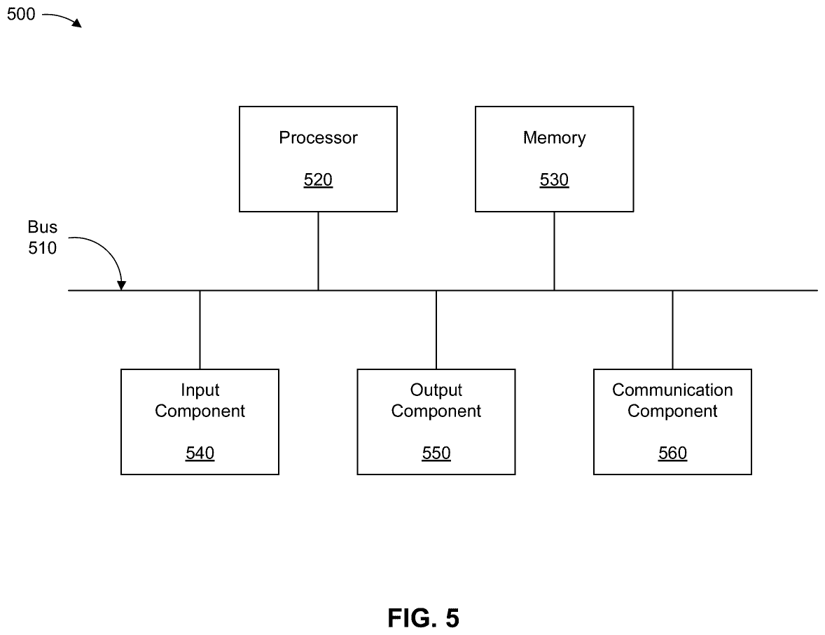

FIG. 1 is a diagram of an example 100 associated with dynamic, token-based content delivery system. As shown in FIG. 1, example 100 includes a client device, a web server, a content asset server, and a user device. These devices are described in more detail in connection with FIGS. 4 and 5. As described herein, the client device may be associated with a client and may implement a UI (e.g., a graphical UI), such as a web browser, a mobile application, a display system, an interactive chat and/or chatbot system, or another suitable channel or platform. For example, the client device may include a web browser application, which the client may execute to load web pages. Similarly, the user device may be associated with a user and may implement a UI (e.g., a graphical UI), such as a web browser, a mobile application, a digital display system, an interactive chat and/or chatbot system, or another suitable channel or platform. For example, the user device may include a web browser application, which the user may execute to load web pages.

As shown by reference number 105, the client device may submit, and the web server may receive, a request for a content asset. In some implementations, the request may include information associated with a request for one or more specific content assets, one or more content asset types, one or more content asset formatting parameters, and/or a designation of an active period for the content asset (e.g., designating a time period during which the content asset may be available for delivery to a user device), among other examples. For example, a client may submit a request that selects a content asset or other resource, and the request may specify the content asset type (e.g., image, animation, video, or the like), a content asset formatting parameter (e.g., formatted and/or sized for desktop-based browser or mobile application, formatted for responsive sizing adaptations, or the like), and/or a designation of an active period (e.g., a request that the content asset be available for a one-month period). For example, where the content asset is related to a time-sensitive event (e.g., a new product launch, an event, or a time-dependent promotion, among other examples), the client may request that the content asset be available only for a specified time period. In some implementations, upon expiration of the time period, the system may deliver an updated content asset (e.g., a universal or generic content asset) in response to requests associated with a content element, as discussed herein. Additionally, or alternatively, the request may include information related to a client profile associated with the client device, including identification information or authorization or authentication information (e.g., login and/or password information, among other examples).

As shown by reference number 110, an embed compiler module may select a set of content assets, from a content asset server, that are responsive to the request. For example, the embed compiler module may select a plurality of images that are responsive to the request, where each image of the plurality of images may be associated with a different size, format, orientation, interactivity capability, or dynamic level (e.g., animated versus static), among other examples. In some implementations, the embed compiler module may be integrated with the web server, or the embed compiler module may be in communication with the web server.

Additionally, the embed compiler module may obtain decision information defining one or more conditions for selecting a content asset from a set of content assets. For example, the decision information may include one or more conditions related to the client profile associated with the client device, including permission and/or authentication conditions related to the content asset. In this way, the embed compiler module may select one or more content assets from the set of content assets based on the decision information. For example, where the client profile is determined to be associated with an unauthorized client, the system may refrain from responding to the request or may select content assets that are approved or authorized for the client profile. Additionally, or alternatively, the decision information may include one or more conditions related to the information (e.g., one or more display parameters) included with the request from the client device. For example, the conditions may be related to a content asset type, a content asset formatting parameter, and/or a designation of an active period. For example, where the client profile is associated with exclusively mobile applications, the embed compiler module may select a content asset that is suitably sized and format for mobile applications.

As shown by reference number 115, the embed compiler module may generate a content element associated with the selected content asset, and the content element may include a token associated with one or more conditions for providing the content asset to a device. In some implementations, the content element may be an embeddable code (e.g., a JavaScript-based embed code) that facilitates a request to the web server and/or the content asset server to fetch and render the requested content asset (e.g., a current version of the content asset).

Additionally, or alternatively, the token may include information related to the client device profile, the content asset type, the content asset formatting parameter, and/or the designation of an active period. As a result, the system may monitor usage information (e.g., via the token associated with the content element) related to the content asset in circumstances in which one or more devices request the content asset via the content element. In this way, the content asset may be delivered to one or more devices (e.g., as requested via the content element) while the content asset may reside on the web server and/or a content asset server of the hosting entity.

In some implementations, the content element and/or the token may be configured with an expiration time at which the content element and/or the token may become inactive. Additionally, or alternatively, the analytics module may store data and/or information obtained via the token, for a specified period of time. For example, where the web server is configured with a privacy configuration that indicates a time period during which user device data may be stored, the web server may configure the content element and/or the token to become inactive or partially inactive according to the privacy configuration.

As shown by reference number 120, the embed compiler module (e.g., associated with the web server) may provide, and the client device may receive, the content element, including the token. In some implementations, the client device may implement or embed the content element in a platform (e.g., a web page, a mobile application, a server, or the like) in which the user device may utilize the content element to request the related content asset. Additionally, or alternatively, one or more additional devices associated with the client device may implement or embed the content element in the platform in which the user device may utilize the content element to request the related content asset. In some implementations, the client device (or the one or more additional devices associated with the client device) may implement or embed the content element in a server that hosts the platform (e.g., a web page, a mobile application, or the like) by which the user device (e.g., via a browser or a mobile application) may utilize the content element to request the related content asset. For example, a client (e.g., via the client device) may embed the content element in a web page that is associated with the client, and the user device (e.g., using a web browser) may utilize the content element to request the content asset as part of loading the web page on the user device. Similarly, for example, the client (e.g., using the client device) may embed the content in storage device (e.g., a server) for a digital display (e.g., an on-premises display, an in-store display, or a digital billboard, among other examples), and the digital display may utilize the content element to request the content asset in order to serve the content asset on the digital display.

As shown by reference number 125, the user device may send, and the content asset server may receive, a request for the content element. In some implementations, the content asset server may be integrated with the web server and/or the content asset server may be in communication with the web server.

As shown by reference number 130, the content asset server may provide, and the user device may receive, the selected content asset, associated with the content element, based on the request for the content element satisfying at least one condition of the one or more conditions associated with the token. For example, the content asset server may validate the token associated with the content element prior to providing the selected content asset. In some implementations, the content asset server may provide the selected content asset based on a determination that the token is associated with a client profile that is authorized for the selected content asset. For example, where the content asset server receives a request for a content element, and the token associated with the content element is related to an authorized client profile, the content asset server may provide, to the user device, the content asset associated with the content element. In contrast, where the token associated with the content element is related to an unauthorized client profile, the content asset server may refrain from providing, to the user device, the content asset associated with the content element.

As a result, the system may prevent a user device from receiving a content asset associated with a content element. In this way, where the system may initially provide a content element to a client device and the client device includes the content element on a web page associated with the client, the system may subsequently revoke the ability to receive the content asset via the content element (e.g., via the content element embedded or included in the web page). For example, the system may monitor usage of the token associated with a content element that is included on a web page, and if the system determines that the token becomes associated with an unauthorized status, the content asset server may refrain from delivering the content asset (e.g., associated with the content element) to a user device that requests the content element. As a result, the content asset server may refrain from delivering any content asset, associated with the content element, to the user device that requests the content element. For example, where a client is authorized to receive content elements from the web server, but the client subsequently loses authorization, the content asset server may refrain from delivering content assets in response to requests for content elements that include a token associated with the client (e.g., a client profile).

Additionally, or alternatively, the content asset server may deliver a contingent (e.g., a fallback) content asset based on a determination that the token is associated with an unauthorized status for the content asset. For example, a web page may be embedded with a content element that includes a token associated with an authorized status, and the content element may enable a request for a content asset that is associated with an active time period (e.g., a promotional campaign). At the expiration of the active time period (e.g., at the end of a promotional campaign), the token may become associated with an unauthorized status, and as a result, the content asset server may deliver an updated or contingent content asset (e.g., unrelated to a promotional campaign) in response to receiving a request for the content element.

In some implementations, the content asset server may adapt and/or update the content asset that is associated with the content element. In some implementations, the web server may obtain an updated set of content assets responsive to the request, from the user device, for the content element, and the web server may select an updated content asset from the updated set of content assets based on the decision information, where the web server may associate the updated content asset with the content element. As a result, the content asset server may provide, to the user device, the selected updated content asset. For example, in circumstances in which a content asset becomes outdated and/or is replaced by an updated content asset, the web server may select an updated content asset to be associated with the content element.

Additionally, or alternatively, the content element may include a set of instructions for displaying the selected content asset and applying one or more display adaptations in order to alter the content asset according to the display parameters associated with the decision information. For example, the set of instruction may indicate that the content asset is to be displayed and/or adapted according to information associated with the user device (e.g., browser type, screen size, or the like) and/or the user (e.g., the user profile, behavior information associated with the user device, or the like).

As shown by reference number 135, an analytics module (e.g., integrated with and/or in communication with the web server) may obtain and adapt content asset data. In some implementations, the analytics module may monitor activity and information associated with the token in order to obtain usage information associated with the token. For example, because the token may be specific to a client, a platform associated with the client (e.g., a web page or a mobile application, among other examples), a specific content type (e.g., associated with a specific promotional campaign, a product, an industry segment, or a channel, among other examples), or the like, the analytics module may obtain activity and information that is specific to the client, the platform associated with the client, or the specific content type.

In some implementations, the token may include information related to the client device profile, the content asset type, the content asset formatting parameter, and/or the designation of an active period. As a result, the system may monitor usage information related to the content asset in circumstances in which one or more devices request the content asset via the content element. In this way, the content asset may be delivered to one or more devices (e.g., as requested via the content element) while the content asset may reside on the web server and/or a content asset server of the hosting entity.

Additionally, or alternatively, as part of receiving the request for the content element and/or as part of providing and adapting the content asset, the content asset server and/or the web server may obtain behavior information associated with the user device. In some implementations, the analytics module may log the behavior information in reference to the token associated with the content element that is utilized (e.g., by the user device) to request the content asset. For example, the behavior information may include historical information and/or real time information associated with a user and/or user profile for the user device. Such behavior information may include data associated with interactions between the user and a client platform, including impressions, mouse movements, clicks, interactions (e.g., with content elements, with CTA elements, or the like), time-based interactions (e.g., measuring time periods between interactions, or the like), time-based indicators (e.g., time spent hovering a mouse over content, time spent viewing certain content, session duration, or the like), video and/or audio plays, event tracking, rage clicks (e.g., repeated clicks on non-responsive content elements), scroll speed, navigation path (e.g., navigation to a linked page, navigation path associated with the user journey to the web page, navigation of a mouse on the web page, or the like), text input, highlighting and/or copying and pasting of web page content, utilization of web browser plugins, and/or eye tracking data (e.g., monitored via one or more cameras integrated with and/or external to the user device), among other examples. As a result, the embed compiler module may obtain updated decision information based on the behavior information, and the embed compiler may select an updated content asset from the set of content assets based on the updated decision information. The updated content asset may be associated with the content element, thereby enabling the updated content asset to be provided to the user device in response to the user device submitting a request for the content element.

Additionally, or alternatively, the analytics module may obtain predicted behavior information associated with the user device. In some implementations, the predicted behavior information may be based on historical behavior information associated with the user of the user device and/or with a user profile associated with the user device. Additionally, or alternatively, the predicted behavior information may be based on real-time or near-real-time behavior information associated with the user of the user device and/or with a user profile associated with the user device. For example, as part of receiving the request for the content element and/or as part of providing and adapting the content asset, the content asset server and/or the web server may obtain a user profile associated with the user device. As a result, the analytics module may utilize historical behavior information associated with the user device to predict the behavior of the user according to one or more artificial intelligence and/or machine learning (AI/ML) techniques, described herein. In this way, the embed compiler module may obtain updated decision information based on the behavior information, and the embed compiler may select an updated content asset from the set of content assets based on the updated decision information. For example, where the user is predicted to be in a high-intent state (e.g., the user is predicted to be ready to make a purchase or interact with a CTA), the embed compiler module may select a content asset that is tailored to the high-intent state (e.g., content emphasizing a CTA or a promotion, among other examples). In contrast, for example, where the user is predicted to be in a low-intent state (e.g., the user is predicted to be browsing or unlikely to interact with a CTA), the embed compiler module may select a content asset that is tailored to the low intent state (e.g., relatively generic content or content intended to move the user towards a high-intent state, among other examples).

Additionally, or alternatively, the analytics module may capture contextual information associated with requests, from the user device, for the content element. For example, the analytics module may capture contextual information associated with a traffic source (e.g., an affiliate link, a referral link, a search engine result, or the like), a campaign source (e.g., an email campaign, a social media campaign, a promotional campaign, or the like), a channel type (e.g., browser type, operating system, screen size, browser settings, plugins, or the like), internet protocol (IP) address, cookie data, tracking pixel data, location and time data, cross-site tracking data, entity tags, supercookies, and/or saved user preferences, among other examples. Accordingly, such contextual information may be utilized to update the decision information for selecting a content asset from the set of content assets.

Additionally, or alternatively, where the embed compiler module has selected an updated content asset, the content asset server and/or the web server may provide the updated content asset to additional user devices that have submitted requests for the content element. For example, because the token may be specific to the content element, the content asset server and/or the web server may provide the updated content asset to each additional user device that submits a request for the content element associated with a previously-selected content asset. In this way, the token may enable all channels and/or platforms associated with the token to be synchronized with the same content assets. For example, where a client utilizes a content element across multiple web pages, mobile application interfaces, or digital displays, the content-element-specific token enables the content asset server and/or the web server to provide a consistent, synchronized content asset across a client's platforms and/or channels.

As shown by reference number 140 the analytics module may provide content asset data to the client device, and/or the analytics module may adapt content asset data (e.g., provide the embed compiler module with data or recommendations for adapting the content asset) based on content asset data received from the client device. In some implementations the web server may select an updated content asset based on content asset data satisfying one or more conditions that are associated with the token that is included in a content element. For example, in circumstances in which a content element enables a request for a content asset related to a certain product, the analytics module may obtain content asset data from the client device indicating that the product is out-of-stock. As a result, the embed compiler module may update the content asset (e.g., the content asset related to the content element) to feature content related to a different product that is in-stock, thereby ensuring that a relevant, usable content asset is delivered to a user device.

As described herein, some implementations may enable dynamically delivering content in a UI by using a token-based content element. For example, where a client obtains a content element associated with a content asset from a web server, the client may utilize the content element to enable a web browser to request the content asset, via the content element. Furthermore, where the content element is associated with a token, the web server may monitor usage of the content element in order to restrict access to the content asset and/or to update or adapt the content asset. For example, the web server may cease delivering content assets to a web page based on the client, associated with the web page, losing authorization for the content assets. Similarly, for example, the system may refrain from delivering a content asset to a web page based on the content asset being unsuitable for the web page. Instead, the system may deliver an updated or adapted content asset that is suitable for the platform (e.g., the web page) or format.

As a result, the web server may monitor and restrict access to and delivery of content assets. In this way, computing resources and/or network resources may be conserved by reducing delivery of content assets to unauthorized platforms and/or by avoiding delivery of out-of-date content assets or content that is unsuitable for a platform. For example, delivering content that is unsuitable for a platform that is unauthorized for use on a web page associated with a specific client, may cause higher processor and memory usage on backend servers that host, provide, and deliver content to unauthorized platforms (e.g., associated with an unauthorized client). Similarly, for example, delivery of outdated or irrelevant content may result in unnecessary processor and memory usage on backend servers that host, provide, and deliver content to a platform (e.g., a web page, mobile application, or the like) associated with a client. Accordingly, by utilizing a dynamic, token-based content delivery system, the web server may provide and deliver content only to authorized platforms (e.g., associated with authorized client) and may provide and deliver content that is up-to-date.

Furthermore, by adapting and updating content assets associated with a content element, the web server may conserve resources that may otherwise be consumed where a user leaves the web page, is unable to efficiently navigate the webpage, or becomes inactive on the webpage. Additionally, by adapting and updating the content assets based on user behavior, user interaction history, user profiles, or the like, some implementations described herein may increase conversion rates or interactions, improve user experience, and avoid wasting resources that may have been consumed by the user navigating and interacting with the web page without completing a conversion action and/or without completing the task that the user intended to perform.

As indicated above, FIG. 1 is provided as an example. Other examples may differ from what is described with regard to FIG. 1.

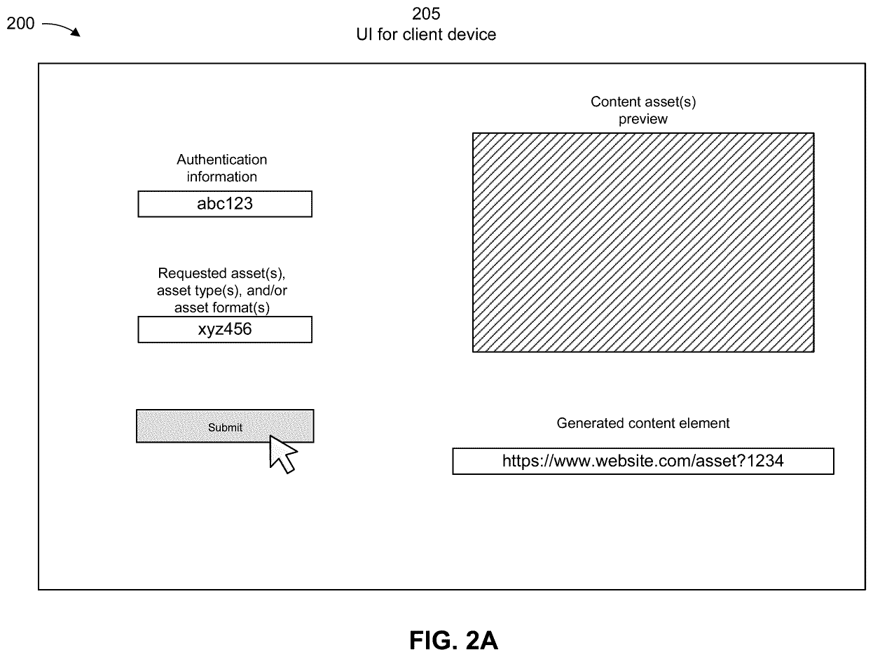

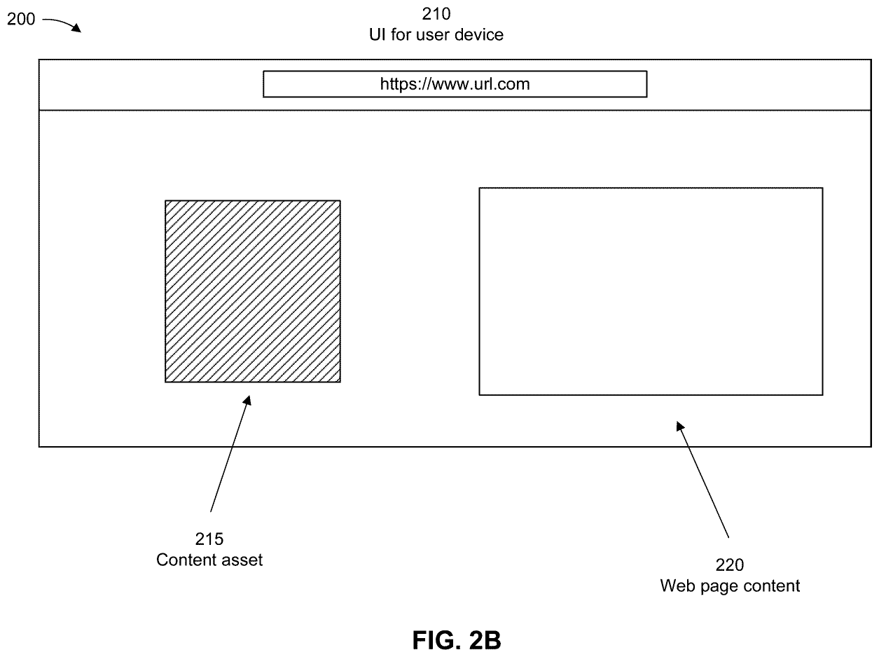

FIGS. 2A-2B are diagrams of an example environment 200 associated with dynamic, token-based content delivery. As shown in FIGS. 2A-2B, example 200 includes a client device 410 and a user device 440. These devices are described in more detail in connection with FIGS. 4 and 5. Additionally, FIGS. 2A-2B are a particular example implementation of FIG. 1 in a client device and user device use case.

As shown in FIG. 2A, a UI 205 for a client device may include UI elements for requesting display content. For example, the UI 205 for the client device may be accessed by a client device, which may include a desktop computer, laptop computer, tablet, mobile phone, or the like. In some implementations, the UI 205 for the client device may include one or more input components by which a client may input information associated with the request for display content. For example, the input components may include text inputs, file uploads, radio buttons or dropdown menus, or interactive components, among other examples.

In some implementations, the client device may be used to input information related to authentication of the client device and/or the client submitting the request for display content via the client device. For example, such authentication information may include username and password, authentication key or authentication code information, two-factor authentication information, or other information that may be used to determine the identity of the client (e.g., for determining whether the client is authorized to receive a content element associated with the requested display content). In some implementations, the client device may be used to input information related to an identifier (e.g., a file name, content name, or the like) associated with the requested display content (e.g., a requested content asset) in order to indicate the display content that is being requested. Additionally, the client device may be used to input information related to content type (e.g., image file, video file, animation file, or the like) and/or content format (e.g., content size, content orientation, content scaling, formatting responsiveness, expiration date, or the like) associated with the requested display content (e.g., the requested content asset).

In some implementations, the UI 205 for the client device may present the content asset (e.g., provide a preview of the content asset) that is requested according to the input from the client device. In some implementations, the UI 205 for the client device may present the content asset in an encrypted and/or obfuscated format. For example, the UI 205 for the client device may utilize image obfuscation (e.g., distorting the pixels, color palette, color tone, or the like of an image), puzzle masking (e.g., breaking the image into tiles and scrambling them), visual watermarking (e.g., adding semi-transparent text, patterns, logos, or the like to an image), among other examples. As a result, the UI 205 for the client device may prevent the client from exporting (e.g., saving an image file, copy-and-pasting an image, screenshotting an image, or the like) the content asset without utilizing the generated content element (e.g., utilizing the content asset without the token associated with the content element).

In some implementations, the UI 205 for the client device may include an interactive button enabling the client to submit the request for display content, after inputting information into one or more of the input components. For example, upon the client device interacting with the interactive button, the client device may send, and a web server may receive, the request for the display content. In response, the web server may generate and provide, and the client device may receive, a content element associated with the content asset.

As shown in FIG. 2B, a UI 210 for a user device may display a content asset 215 (e.g., images, videos, animations, interactive components, or the like), received from the web server, on a web browser, mobile application, or digital display, among other examples. For example, the web browser associated with the client device may utilize a content element associated with a web page to send a request, to the web server (e.g., a content asset server), for a content element. In response, the web server (e.g., the content asset server) may send, and the user device may receive, the content asset 215 associated with the content element. As a result, the UI 210 for the user device (e.g., the web browser) may display the web page, including the content asset 215. Additionally, in some implementations, the UI 210 for the user device may include webpage content 220 (e.g., images, text, animations, video, or the like) that is unrelated to the content asset 215 received from the web server.

As described herein, some implementations may enable dynamically delivering content in a UI by using a token-based content element. For example, where a client obtains a content element associated with a content asset from a web server, the client may utilize the content element to enable a web browser to request the content asset, via the content element. Furthermore, where the content element is associated with a token, the web server may monitor usage of the content element in order to restrict access to the content asset and/or to update or adapt the content asset. As a result, computing resources and/or network resources may be conserved by reducing delivery of content assets to unauthorized platforms and/or by avoiding delivery of out-of-date content assets or content that is unsuitable for a platform. For example, delivering content that is unsuitable for a platform that is unauthorized for use on a web page associated with a specific client, may cause higher processor and memory usage on backend servers that host, provide, and deliver content to unauthorized platforms (e.g., associated with an unauthorized client). Similarly, for example, delivery of outdated or irrelevant content may result in unnecessary processor and memory usage on backend servers that host, provide, and deliver content to a platform (e.g., a web page, mobile application, or the like) associated with a client. Accordingly, by utilizing a dynamic, token-based content delivery system, the web server may provide and deliver content only to authorized platforms (e.g., associated with authorized client) and may provide and deliver content that is up-to-date.

Furthermore, by adapting and updating content assets associated with a content element, the web server may conserve resources that may otherwise be consumed where a user leaves the web page, is unable to efficiently navigate the webpage, or becomes inactive on the webpage. Additionally, by adapting and updating the content assets based on user behavior, user interaction history, user profiles, or the like, some implementations described herein may increase conversion rates or interactions, improve user experience, and avoid wasting resources that may have been consumed by the user navigating and interacting with the web page without completing a conversion action and/or without completing the task that the user intended to perform.

As indicated above, FIGS. 2A-2B are provided as an example. Other examples may differ from what is described with regard to FIGS. 2A-2B.

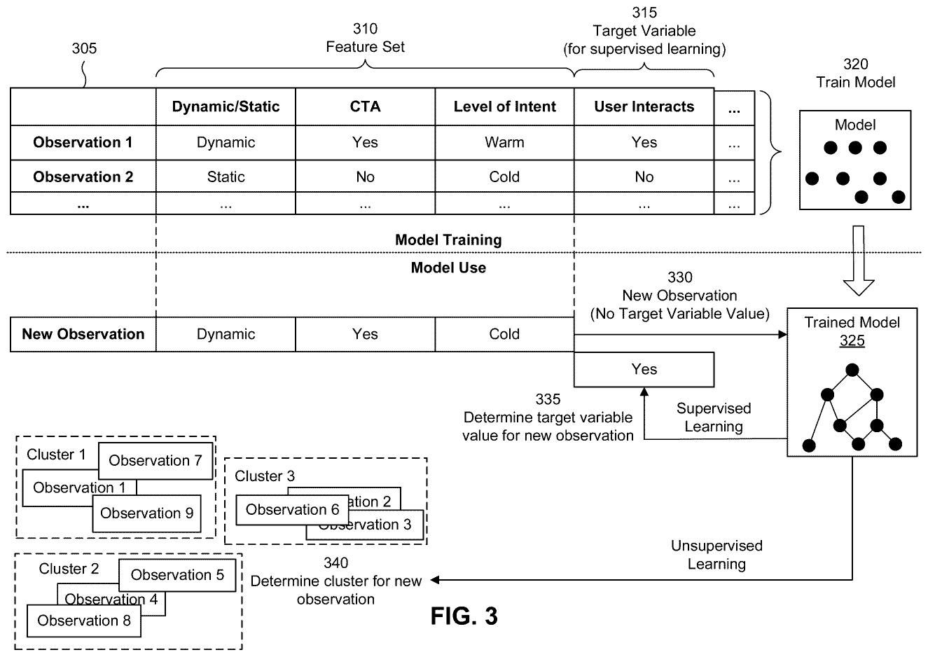

FIG. 3 is a diagram of an example 300 of training and using a machine learning model in connection with dynamic, token-based content delivery. The machine learning model training and usage described herein may be performed using a machine learning system. The machine learning system may include or may be included in a computing device, a server, a cloud computing environment, or the like, such as the server, the client device, and/or the user device described in more detail elsewhere herein.

As shown by reference number 305, a machine learning model may be trained using a set of observations. The set of observations may be obtained from training data (e.g., historical data), such as data gathered during one or more processes described herein. In some implementations, the machine learning system may receive the set of observations (e.g., as input) from a server, a client device, a user device, a user context data repository (e.g., including information associated with a user and/or a user profile), and/or another suitable data source, as described elsewhere herein.

As shown by reference number 310, the set of observations may include a feature set. The feature set may include a set of variables, and a variable may be referred to as a feature. A specific observation may include a set of variable values (or feature values) corresponding to the set of variables. In some implementations, the machine learning system may determine variables for a set of observations and/or variable values for a specific observation based on input received from a server, a client device, a user device, a user context data repository, and/or another suitable data source. For example, the machine learning system may identify a feature set (e.g., one or more features and/or feature values) by extracting the feature set from structured data, by performing natural language processing and/or computer vision processing to extract the feature set from unstructured data, and/or by receiving input from an operator.

As an example, a feature set for a set of observations may include a first feature of Dynamic/Static, a second feature of CTA, a third feature of Level of Intent, and so on. As shown, for a first observation, the first feature may have a value of Dynamic (e.g., indicating that the content asset includes dynamic content, including an animation, video, or the like), the second feature may have a value of Yes (e.g., indicating that the content asset includes a CTA element), the third feature may have a value of Warm (e.g., indicating that the user profile associated with the user device has interacted with certain UI elements of the web page according to one or more interaction conditions and/or indicating that the user has interacted with a quantity of UI elements that satisfies (e.g., meets or exceeds) an interaction threshold), and so on. These features and feature values are provided as examples, and may differ in other examples. For example, the feature set may include one or more of the following features: content asset type (e.g., image, video, animation, or the like), content asset format (e.g., content size, content orientation, or the like) user navigation path (e.g., navigation to a linked page, navigation path associated with the user journey to the web page, referral source, or the like), utilization of web browser plugins, eye tracking data, user behavior information, scroll activity, and/or click activity, among other examples.

As shown by reference number 315, the set of observations may be associated with a target variable. The target variable may represent a variable having a binary attribute (e.g., yes or no), may represent a numeric value, may represent a variable having a numeric value that falls within a range of values or has some discrete possible values, may represent a variable that is selectable from one of multiple options (e.g., one of multiples classes, classifications, or labels) and/or may represent a variable having a Boolean value. A target variable may be associated with a target variable value, and a target variable value may be specific to an observation. In example 300, the target variable is User Interacts (e.g., user interacts with one or more elements of the web page), which has a value of Yes for the first observation.

The feature set and target variable described above are provided as examples, and other examples may differ from what is described above. For example, for a target variable of User Converts (e.g., makes a purchase, requests more information, provides requested information, signs up for a promotion, or the like), the feature set may include a No option (e.g., the user did not start a conversion action), an Abandoned option (e.g., the user started, but did not complete, the conversion action), a Completed option (e.g., the user completed the conversion action), or the like.

The target variable may represent a value that a machine learning model is being trained to predict, and the feature set may represent the variables that are input to a trained machine learning model to predict a value for the target variable. The set of observations may include target variable values so that the machine learning model can be trained to recognize patterns in the feature set that lead to a target variable value. A machine learning model that is trained to predict a target variable value may be referred to as a supervised learning model.

In some implementations, the machine learning model may be trained on a set of observations that do not include a target variable. This may be referred to as an unsupervised learning model. In this case, the machine learning model may learn patterns from the set of observations without labeling or supervision, and may provide output that indicates such patterns, such as by using clustering and/or association to identify related groups of items within the set of observations.

As shown by reference number 320, the machine learning system may train a machine learning model using the set of observations and using one or more machine learning algorithms, such as a regression algorithm, a decision tree algorithm, a neural network algorithm, a k-nearest neighbor algorithm, a support vector machine algorithm, or the like. After training, the machine learning system may store the machine learning model as a trained machine learning model 325 to be used to analyze new observations.

As an example, the machine learning system may obtain training data for the set of observations based on historical data indicating whether a user has interacted with an element of a web page, historical interaction properties associated with the element of the web page, and/or updated interaction properties associated with one or more elements of the web page that have been presented to one or more users, detected user device types, or the like.

As shown by reference number 330, the machine learning system may apply the trained machine learning model 325 to a new observation, such as by receiving a new observation and inputting the new observation to the trained machine learning model 325. As shown, the new observation may include a first feature of Dynamic (e.g., indicating that the content asset includes dynamic content, including an animation, video, or the like), a second feature of Yes (e.g., indicating that the user interacted with a CTA), and a third feature of Cold (e.g., indicating that the user has interacted with certain UI elements of the web page according to one or more interaction conditions and/or indicating that the user has interacted with a quantity of UI elements that fails (e.g., is less than) an interaction threshold), and so on, as an example. The machine learning system may apply the trained machine learning model 325 to the new observation to generate an output (e.g., a result). The type of output may depend on the type of machine learning model and/or the type of machine learning task being performed. For example, the output may include a predicted value of a target variable, such as when supervised learning is employed. Additionally, or alternatively, the output may include information that identifies a cluster to which the new observation belongs and/or information that indicates a degree of similarity between the new observation and one or more other observations, such as when unsupervised learning is employed.

As an example, the trained machine learning model 325 may predict a value of Yes for the target variable of User Interacts for the new observation, as shown by reference number 335. Based on this prediction, the machine learning system may provide a first recommendation, may provide output for determination of a first recommendation, may perform a first automated action, and/or may cause a first automated action to be performed (e.g., by instructing another device to perform the automated action), among other examples. The first recommendation may include, for example, a recommendation for the web server to refrain from updating the content asset associated with the content element (e.g., the content element delivered, from a content asset server, to the user device) in order to encourage the user to continue interacting with the web page and/or to retain user interaction with the web page. The first automated action may include, for example, retaining (e.g., refraining from updating) the content asset associated with the content element in an attempt to encourage the user to continue interacting with the web page and/or to retain the user on the web page.

As another example, if the machine learning system were to predict a value of No for the target variable of User Interacts, then the machine learning system may provide a second (e.g., different) recommendation (e.g., recommending that the web server update the content asset associated with the content element in order to deliver the updated content asset to the user device), and/or may perform or cause performance of a second (e.g., different) automated action (e.g., updating the content asset associated with the content element and deliver the updated content asset to the user device).

In some implementations, the trained machine learning model 325 may classify (e.g., cluster) the new observation in a cluster, as shown by reference number 340. The observations within a cluster may have a threshold degree of similarity. As an example, if the machine learning system classifies the new observation in a first cluster (e.g., User Interacts), then the machine learning system may provide a first recommendation, such as the first recommendation described above. Additionally, or alternatively, the machine learning system may perform a first automated action and/or may cause a first automated action to be performed (e.g., by instructing another device to perform the automated action) based on classifying the new observation in the first cluster, such as the first automated action described above.

As another example, if the machine learning system were to classify the new observation in a second cluster (e.g., user does not interact), then the machine learning system may provide a second (e.g., different) recommendation, such as the second recommendation described above, and/or may perform or cause performance of a second (e.g., different) automated action, such as the second automated action described above.

In some implementations, the recommendation and/or the automated action associated with the new observation may be based on a target variable value having a particular label (e.g., classification or categorization), may be based on whether a target variable value satisfies one or more thresholds (e.g., whether the target variable value is greater than a threshold, is less than a threshold, is equal to a threshold, falls within a range of threshold values, or the like), and/or may be based on a cluster in which the new observation is classified.

In some implementations, the trained machine learning model 325 may be re-trained using feedback information. For example, feedback may be provided to the machine learning model. The feedback may be associated with actions performed based on the recommendations provided by the trained machine learning model 325 and/or automated actions performed, or caused, by the trained machine learning model 325. In other words, the recommendations and/or actions output by the trained machine learning model 325 may be used as inputs to re-train the machine learning model (e.g., a feedback loop may be used to train and/or update the machine learning model). For example, the feedback information may include information that is obtained or otherwise gathered via an instance of dynamic, token-based content delivery.

In this way, the machine learning system may apply a rigorous and automated process to determine whether and how to update the content asset associated with the content element. The machine learning system may enable recognition and/or identification of tens, hundreds, thousands, or millions of features and/or feature values for tens, hundreds, thousands, or millions of observations, thereby increasing accuracy and consistency and reducing delay associated with updating the content asset associated with the content element based on behavior information associated with the user, relative to requiring computing resources to be allocated for tens, hundreds, or thousands of operators to manually update content assets associated with the content element based on behavior information associated with the user.

As indicated above, FIG. 3 is provided as an example. Other examples may differ from what is described with regard to FIG. 3.

FIG. 4 is a diagram of an example environment 400 in which systems and/or methods described herein may be implemented. As shown in FIG. 4, environment 400 may include a client device 410, a content asset server 420, a web server 430, a user device 440, and a network 450. Devices of environment 400 may interconnect via wired connections, wireless connections, or a combination of wired and wireless connections.

The client device 410 may include one or more devices capable of receiving, generating, storing, processing, and/or providing information associated with dynamic, token-based content delivery, as described elsewhere herein. The client device 410 may include a communication device and/or a computing device. For example, the client device 410 may include a wireless communication device, a mobile phone, a user equipment, a laptop computer, a tablet computer, a desktop computer, a wearable communication device (e.g., a smart wristwatch, a pair of smart eyeglasses, a head mounted display, or a virtual reality headset), or a similar type of device.

The content asset server 420 may include one or more devices capable of receiving, generating, storing, processing, providing, and/or routing information associated with dynamic, token-based content delivery, as described elsewhere herein. The content asset server 420 may include a communication device and/or a computing device. For example, the content asset server 420 may include a server, such as an application server, a client server, a web server, a database server, a host server, a proxy server, a virtual server (e.g., executing on computing hardware), or a server in a cloud computing system. In some implementations, the content asset server 420 may include computing hardware used in a cloud computing environment, such as one or more serverless components (e.g., one or more serverless functions), among other examples.

The web server 430 may include one or more devices capable of receiving, generating, storing, processing, providing, and/or routing information associated with dynamic, token-based content delivery, as described elsewhere herein. The web server 430 may include a communication device and/or a computing device. For example, the web server 430 may include a server, such as an application server, a client server, a web server, a database server, a host server, a proxy server, a virtual server (e.g., executing on computing hardware), or a server in a cloud computing system. In some implementations, the web server 430 may include computing hardware used in a cloud computing environment, such as one or more serverless components (e.g., one or more serverless functions), among other examples.

The user device 440 may include one or more devices capable of receiving, generating, storing, processing, and/or providing information associated with dynamic, token-based content delivery, as described elsewhere herein. The user device 440 may include a communication device and/or a computing device. For example, the user device 440 may include a wireless communication device, a mobile phone, a user equipment, a laptop computer, a tablet computer, a desktop computer, a digital display, a gaming console, a set-top box, a wearable communication device (e.g., a smart wristwatch, a pair of smart eyeglasses, a head mounted display, or a virtual reality headset), or a similar type of device.

The network 450 may include one or more wired and/or wireless networks. For example, the network 450 may include a wireless wide area network (e.g., a cellular network or a public land mobile network), a local area network (e.g., a wired local area network or a wireless local area network (WLAN), such as a Wi-Fi network), a personal area network (e.g., a Bluetooth network), a near-field communication network, a telephone network, a private network, the Internet, and/or a combination of these or other types of networks. The network 450 enables communication among the devices of environment 400.

The number and arrangement of devices and networks shown in FIG. 4 are provided as an example. In practice, there may be additional devices and/or networks, fewer devices and/or networks, different devices and/or networks, or differently arranged devices and/or networks than those shown in FIG. 4. Furthermore, two or more devices shown in FIG. 4 may be implemented within a single device, or a single device shown in FIG. 4 may be implemented as multiple, distributed devices. Additionally, or alternatively, a set of devices (e.g., one or more devices) of environment 400 may perform one or more functions described as being performed by another set of devices of environment 400.

FIG. 5 is a diagram of example components of a device 500 associated with a dynamic, token-based content delivery system. The device 500 corresponds to one or more of the client device 410, the content asset server 420, the web server 430, and/or the user device 440. In some implementations, the client device 410, the content asset server 420, the web server 430, and/or the user device 440 include one or more devices 500 and/or one or more components of the device 500. In the example shown in FIG. 5, the device 500 includes a bus 510, a processor 520, a memory 530, an input component 540, an output component 550, and/or a communication component 560.

The bus 510 includes one or more components that enable wired and/or wireless communication among the components of the device 500. The bus 510 couples together two or more components of FIG. 5, such as via operative coupling, communicative coupling, electronic coupling, and/or electric coupling. For example, the bus 510 may include an electrical connection (e.g., a wire, a trace, and/or a lead) and/or a wireless bus. The processor 520 includes a central processing unit, a graphics processing unit, a microprocessor, a controller, a microcontroller, a digital signal processor, a field-programmable gate array, an application-specific integrated circuit, and/or another type of processing component. The processor 520 may be implemented in hardware, firmware, or a combination of hardware and software. In some implementations, the processor 520 includes one or more processors capable of being programmed to perform one or more operations or processes described elsewhere herein.

The memory 530 includes volatile and/or nonvolatile memory, such as random access memory (RAM), read only memory (ROM), a hard disk drive, and/or another type of memory (e.g., a flash memory, a magnetic memory, and/or an optical memory). The memory 530 may include internal memory (e.g., RAM, ROM, or a hard disk drive) and/or removable memory (e.g., removable via a universal serial bus connection). In some implementations, the memory 530 is a non-transitory computer-readable medium. The memory 530 stores information, one or more instructions, and/or software (e.g., one or more software applications) related to the operation of the device 500. In some implementations, the memory 530 includes one or more memories that are coupled (e.g., communicatively coupled) to one or more processors (e.g., processor 520), such as via the bus 510. Communicative coupling between a processor 520 and a memory 530 enables the processor 520 to read and/or process information stored in the memory 530 and/or to store information in the memory 530.

The input component 540 enables the device 500 to receive input, such as user input and/or sensed input. For example, the input component 540 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 550 enables the device 500 to provide output, such as via a display, a speaker, and/or a light-emitting diode. The communication component 560 enables the device 500 to communicate with other devices via a wired connection and/or a wireless connection. For example, the communication component 560 may include a receiver, a transmitter, a transceiver, a modem, a network interface card, and/or an antenna.

In some implementations, the device 500 performs one or more operations or processes described herein. For example, a non-transitory computer-readable medium (e.g., memory 530) may store a set of instructions (e.g., one or more instructions or code) for execution by the processor 520. The processor 520 may execute the set of instructions to perform one or more operations or processes described herein. In some implementations, execution of the set of instructions, by one or more processors 520, causes the one or more processors 520 and/or the device 500 to perform one or more operations or processes described herein. In some implementations, hardwired circuitry is used instead of or in combination with the instructions to perform one or more operations or processes described herein. Additionally, or alternatively, the processor 520 may be configured to perform one or more operations or processes described herein. Thus, implementations described herein are not limited to any specific combination of hardware circuitry and software.

The number and arrangement of components shown in FIG. 5 are provided as an example. The device 500 may include additional components, fewer components, different components, or differently arranged components than those shown in FIG. 5. Additionally, or alternatively, a set of components (e.g., one or more components) of the device 500 may perform one or more functions described as being performed by another set of components of the device 500.

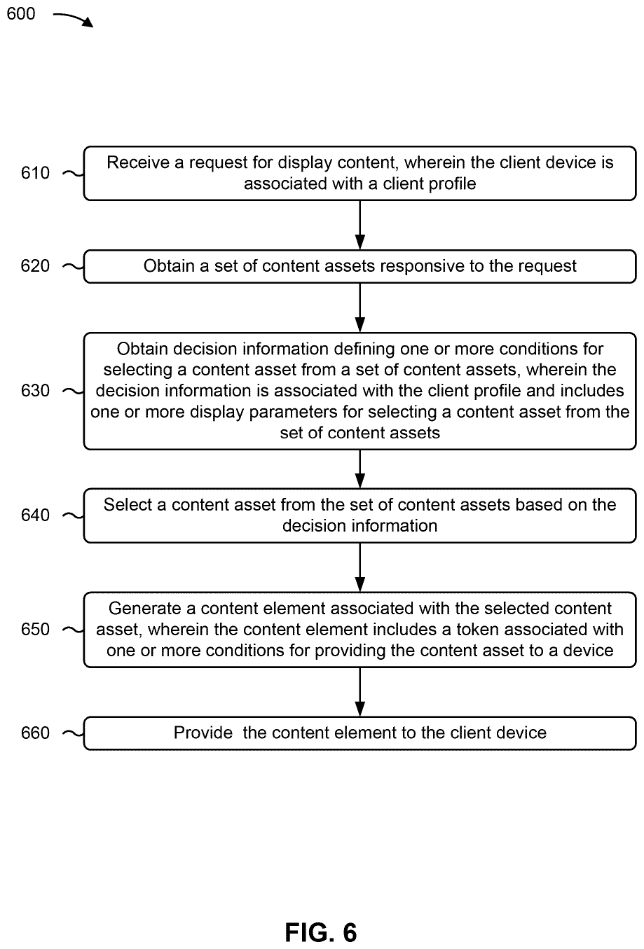

FIG. 6 is a flowchart of an example process 600 associated with a dynamic, token-based content delivery system. In some implementations, one or more process blocks of FIG. 6 may be performed by the web server 430. In some implementations, one or more process blocks of FIG. 6 may be performed by another device or a group of devices separate from or including the web server 430, such as the content asset server 420. Additionally, or alternatively, one or more process blocks of FIG. 6 may be performed by one or more components of the device 500, such as processor 520, memory 530, input component 540, output component 550, and/or communication component 560.

As shown in FIG. 6, process 600 may include receiving, from a client device, a request for display content (block 610). For example, the web server 430 (e.g., using processor 520, memory 530, input component 540, and/or communication component 560) may receive, from a client device, a request for display content, as described above in connection with reference number 105 of FIG. 1. As an example, a retail company may request one or more images from a hosting entity that hosts and provides images for use on the retail company's web pages. In some implementations, the client device may be associated with a client profile. As an example, the request may include information that authenticates the retail company with respect to the request, information related to the retail company's web pages (e.g., web page formatting, web pages responsiveness configuration, or the like), and/or information related to one or more users associated with the retail company, among other examples.

As further shown in FIG. 6, process 600 may include obtaining a set of content assets responsive to the request (block 620). For example, the web server 430 (e.g., using processor 520 and/or memory 530) may obtain a set of content assets responsive to the request, as described above in connection with reference number 110 of FIG. 1. As an example, the web server may utilize information associated with the requested images to select a set of images (e.g., including different image formats, image sizes, image orientations, or the like) that are responsive to the request.

As further shown in FIG. 6, process 600 may include obtaining decision information defining one or more conditions for selecting a content asset from a set of content assets (block 630). For example, the web server 430 (e.g., using processor 520 and/or memory 530) may obtain decision information defining one or more conditions for selecting a content asset from a set of content assets, as described above in connection with reference number 110 of FIG. 1. As an example, the web server may obtain one or more conditions associated with the requested images (e.g., image size, image format, image orientation, or the like) in order to select a quantity of images, from the set of images, that are responsive to the request for the images. In some implementations, the decision information is associated with the client profile and includes one or more display parameters for selecting a content asset from the set of content assets. As an example, the web server may obtain one or more conditions associated with the requested images and with the retail company's profile in order to select images that are suitable for the retail company (e.g., the retail company's web pages) and responsive to the request for the images.

As further shown in FIG. 6, process 600 may include selecting a content asset from the set of content assets based on the decision information (block 640). For example, the web server 430 (e.g., using processor 520 and/or memory 530) may select a content asset from the set of content assets based on the decision information, as described above in connection with reference number 110 of FIG. 1. As an example, the web server may utilize information associated with the requested images and with the retail company's profile in order to select images that are suitable for the retail company (e.g., the retail company's web pages) and responsive to the request for the images.

As further shown in FIG. 6, process 600 may include generating a content element associated with the selected content asset (block 650). For example, the web server 430 (e.g., using processor 520 and/or memory 530) may generate a content element associated with the selected content asset, as described above in connection with reference number 115 of FIG. 1. As an example, the web server may generate a content element that may be utilized (e.g., by a web browser, a mobile application, or the like) to request the content element associated with the image requested by the retail company. In some implementations, the content element includes a token associated with one or more conditions for providing the content asset to a device. As an example, the content element may include a token (e.g., in a universal resource locator (URL) associated with the content element) that may be used to monitor and/or take action with respect to the content element and the associated image.

As further shown in FIG. 6, process 600 may include providing the content element to the client device (block 660). For example, the web server 430 (e.g., using processor 520 and/or memory 530) may provide the content element to the client device, as described above in connection with reference number 120 of FIG. 1. As an example, the web server may provide, and the retail company may receive, the generated content element, and the retail company may include the content element in one or more web pages of the retail company. As a result, in a circumstance in which a user device accesses the one or more pages of the retail company, the user device (e.g., using a web browser) may request the content element, and the web server may deliver the image (e.g., associated with the content element) to the user device.

Although FIG. 6 shows example blocks of process 600, in some implementations, process 600 may include additional blocks, fewer blocks, different blocks, or differently arranged blocks than those depicted in FIG. 6. Additionally, or alternatively, two or more of the blocks of process 600 may be performed in parallel. The process 600 is an example of one process that may be performed by one or more devices described herein. These one or more devices may perform one or more other processes based on operations described herein, such as the operations described in connection with FIGS. 1-3. Moreover, while the process 600 has been described in relation to the devices and components of the preceding figures, the process 600 can be performed using alternative, additional, or fewer devices and/or components. Thus, the process 600 is not limited to being performed with the example devices, components, hardware, and software explicitly enumerated in the preceding figures.

The foregoing disclosure provides illustration and description, but is not intended to be exhaustive or to limit the implementations to the precise forms disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The hardware and/or software code described herein for implementing aspects of the disclosure should not be construed as limiting the scope of the disclosure. Thus, the operation and behavior of the systems and/or methods are described herein without reference to specific software code-it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination and permutation of those items, including single members. As an example, “at least one of: a, b, or c” is intended to cover a, b, c, a-b, a-c, b-c, and a-b-c, as well as any combination with multiple of the same item. As used herein, the term “and/or” used to connect items in a list refers to any combination and any permutation of those items, including single members (e.g., an individual item in the list). As an example, “a, b, and/or c” is intended to cover a, b, c, a-b, a-c, b-c, and a-b-c.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A system for dynamic content delivery, the system comprising:
one or more memories; and
one or more processors, communicatively coupled to the one or more memories, configured to:
receive, from a client device, a request for display content,
wherein the client device is associated with a client profile;
obtain a set of content assets responsive to the request;
obtain decision information defining one or more conditions for selecting a content asset from a set of content assets,
wherein the decision information is associated with the client profile and includes one or more display parameters for selecting a content asset from the set of content assets;
select a content asset from the set of content assets based on the decision information;
generate a content element associated with the selected content asset,
wherein the content element includes a token associated with one or more conditions for providing the content asset to a device; and
provide the content element to the client device.

2. The system of claim 1, wherein the one or more processors are further configured to:
receive, from a user device, a request for the content element; and
provide, to the user device, the selected content asset, associated with the content element, based on the request for the content element satisfying at least one condition of the one or more conditions associated with the token.

3. The system of claim 2, where the one or more processors are further configured to:
obtain behavior information associated with the user device;
obtain updated decision information based on the behavior information;
select an updated content asset from the set of content assets based on the updated decision information,
wherein the updated content asset is associated with the content element; and
provide, to the user device, the selected updated content asset.

4. The system of claim 3, wherein the one or more processors, to obtain the behavior information associated with the user device, are configured to:
obtain predicted behavior information associated with the user device,
wherein the predicted behavior information is based on historical behavior information associated with the user device.

5. The system of claim 3, wherein the one or more processors are further configured to:
provide the selected updated content asset to a plurality of additional user devices,
wherein each additional user device, of the plurality of additional user devices, is associated with an additional request for the content element.

6. The system of claim 2, wherein the one or more processors are further configured to:
obtain an updated set of content assets responsive to the request for the content element;
select an updated content asset from the updated set of content assets based on the decision information,
wherein the selected updated content asset is associated with the content element; and
provide, to the user device, the selected updated content asset.

7. The system of claim 6, wherein the updated set of content assets are obtained based on at least one condition, of the one or more conditions associated with the token, being satisfied.

8. The system of claim 6, wherein the one or more processors are further configured to:
provide the selected updated content assets to a plurality of additional user devices,
wherein each additional user device, of the plurality of additional user devices, is associated with an additional request for the content element.

9. The system of claim 1, wherein the one or more processors are further configured to:
receive, from a user device, a request for the content element; and
refrain from providing the selected content asset, associated with the content element, to the user device, based on the request for the content element failing to satisfy at least one condition of the one or more conditions associated with the token.

10. The system of claim 1, wherein the content element includes a set of instructions for displaying the one or more content assets and applying at least one display adaptation in order to alter the one or more content assets based on the one or more display parameters.

11. A method for dynamic content delivery, comprising:
receiving, from a client device, a request for display content,
wherein the client device is associated with a client profile;
obtaining, by a system, a set of content assets responsive to the request;
obtaining, by the system, decision information defining one or more conditions for selecting a content asset from a set of content assets,
wherein the decision information is associated with the client profile and includes one or more display parameters for selecting a content asset from the set of content assets;
selecting, by the system, a content asset from the set of content assets based on the decision information;
generating, by the system, a content element associated with the selected content asset,
wherein the content element includes a token associated with one or more conditions for providing the content asset to a device; and
providing, by the system, the content element to the client device.

12. The method of claim 11, further comprising:
receiving, from a user device, a request for the content element; and
providing, to the user device, the selected content asset, associated with the content element, based on the request for the content element satisfying at least one condition of the one or more conditions associated with the token.

13. The method of claim 12, further comprising:
obtaining behavior information associated with the user device;
obtaining updated decision information based on the behavior information;
selecting an updated content asset from the set of content assets based on the updated decision information,
wherein the updated content asset is associated with the content element; and
providing, to the user device, the selected updated content asset.

14. The method of claim 12, further comprising:
obtaining an updated set of content assets responsive to the request for the content element;
selecting an updated content asset from the updated set of content assets based on the decision information,
wherein the selected updated content asset is associated with the content element; and
providing, to the user device, the selected updated content asset.

15. The method of claim 11, further comprising:
receiving, from a user device, a request for the content element; and
refraining from providing the selected content asset, associated with the content element, to the user device, based on the request for the content element failing to satisfy at least one condition of the one or more conditions associated with the token.

16. A non-transitory computer-readable medium storing a set of instructions, the set of instructions comprising:
one or more instructions that, when executed by one or more processors of a system, cause the system to:
receive, from a client device, a request for display content,
wherein the client device is associated with a client profile;
obtain a set of content assets responsive to the request;
obtain decision information defining one or more conditions for selecting a content asset from a set of content assets,
wherein the decision information is associated with the client profile and includes one or more display parameters for selecting a content asset from the set of content assets;
select a content asset from the set of content assets based on the decision information;
generate a content element associated with the selected content asset,
wherein the content element includes a token associated with one or more conditions for providing the content asset to a device; and
provide the content element to the client device.

17. The non-transitory computer-readable medium of claim 16, wherein the one or more instructions further cause the system to:
receive, from a user device, a request for the content element; and
provide, to the user device, the selected content asset, associated with the content element, based on the request for the content element satisfying at least one condition of the one or more conditions associated with the token.

18. The non-transitory computer-readable medium of claim 17, where the one or more instructions further cause the system to:
obtain behavior information associated with the user device;
obtain updated decision information based on the behavior information;
select an updated content asset from the set of content assets based on the updated decision information,
wherein the updated content asset is associated with the content element; and
provide, to the user device, the selected updated content asset.

19. The non-transitory computer-readable medium of claim 18, wherein the one or more instructions, that cause the system to obtain the behavior information associated with the user device, cause the system to:
obtain predicted behavior information associated with the user device,
wherein the predicted behavior information is based on historical behavior information associated with the user device.

20. The non-transitory computer-readable medium of claim 16, wherein the one or more instructions further cause the system to:
receive, from a user device, a request for the content element; and
refrain from providing the selected content asset, associated with the content element, to the user device, based on the request for the content element failing to satisfy at least one condition of the one or more conditions associated with the token.
